(19) United States
(12) Patent Application Publication
(10) Pub. No.: US 2011/0024056 A1
(43) Pub. Date: Feb. 3, 2011

(54) PROCESS AND INSTALLATION FOR MAKING PANELS

(76) Inventor: Angelo Candiracci, Fano (Pesaro-Urbino) (IT)

Correspondence Address: YOUNG & THOMPSON, 209 Madison Street, Suite 500, Alexandria, VA, 22314, US

(21) Appl. No.: 12/679,133

(22) PCT Filed: Sep. 17, 2008
(86) PCT No.: PCT/IB08/02415

§ 371 Date: Apr. 2, 2010

(30) Foreign Application Priority Data
Sep. 21, 2007 (IT) BO2007A000638

(51) Int. Cl. B32B 38/10; B32B 38/18

(52) U.S. Cl. 156/521; 156/538; 156/573

(57) ABSTRACT

A process and an installation for making panels (12), in particular panels used for constructing a building. According to this process and installation, first reinforcement elements (16) and second reinforcement elements (18) are fed lengthways simultaneously and the main body (14) of the panel is placed between them.

### TECHNICAL FIELD

This invention relates to a process and an installation for making construction articles, in particular panels or parts thereof.

More specifically, the panels are used for constructing a building or the like.

### BACKGROUND ART

Panels used for building construction are well known. These prior art panels may comprise a panel body, made in particular of expanded polystyrene, with metal reinforcement on the outside. Production of these prior art panels involves making panel reinforcement mesh in sheets of predetermined length corresponding to the length of the polystyrene panel. This is done in a dedicated machine and the expanded polystyrene panel body and the sheets of reinforcement mesh are then assembled in a separate machine.

At the assembling machine, a sheet of reinforcement mesh is first placed on the machine work table, the expanded polystyrene panel body is laid on the sheet and another reinforcement sheet of mesh then laid over the expanded polystyrene panel body.

This process not only requires an excessive amount of space but is also extremely labour-intensive and lengthy since all the components to be assembled are moved by hand.

### SUMMARY OF THE INVENTION

It is provided a process for making construction articles, in particular panels or parts thereof, in particular panels used for constructing a building, each panel comprising a main panel body, made in particular of an insulating material, especially an expanded plastic material, preferably expanded polystyrene, and reinforcement means associated with the panel body. The process is characterized in that first and second reinforcement means to be associated with the main panel body are made to advance in a longitudinal direction.

In this way, two continuous sheets of metallic mesh can be applied simultaneously to make corresponding panels, with obvious advantages in terms of reduced labour intensiveness and floor space saved.

The invention also relates to an advantageous installation for making panels, in particular panels used for constructing a building, or to a magazine for storing respective reinforcement means and to an apparatus for guiding respective reinforcement rods.

### BRIEF DESCRIPTION OF THE DRAWINGS

The technical characteristics and advantageous aspects of the installation are apparent from the detailed description which follows, with reference to the accompanying drawings, which illustrate a preferred embodiment of the intallation provided merely by way of example without restricting the scope of the inventive concept, and in which:

FIG. 1 is a perspective view of a preferred embodiment of the installation according to the invention;

FIG. 2 is a perspective view showing only the area upstream of the preferred embodiment of the installation according to the invention;

FIG. 3 is a perspective view showing an area in the middle of the installation according to the invention, just downstream of the area illustrated in FIG. 2;

FIG. 4 is a perspective view showing an area at the end of the preferred embodiment of the installation according to the invention.

### DESCRIPTION OF THE PREFERRED EMBODIMENTS OF THE INVENTION

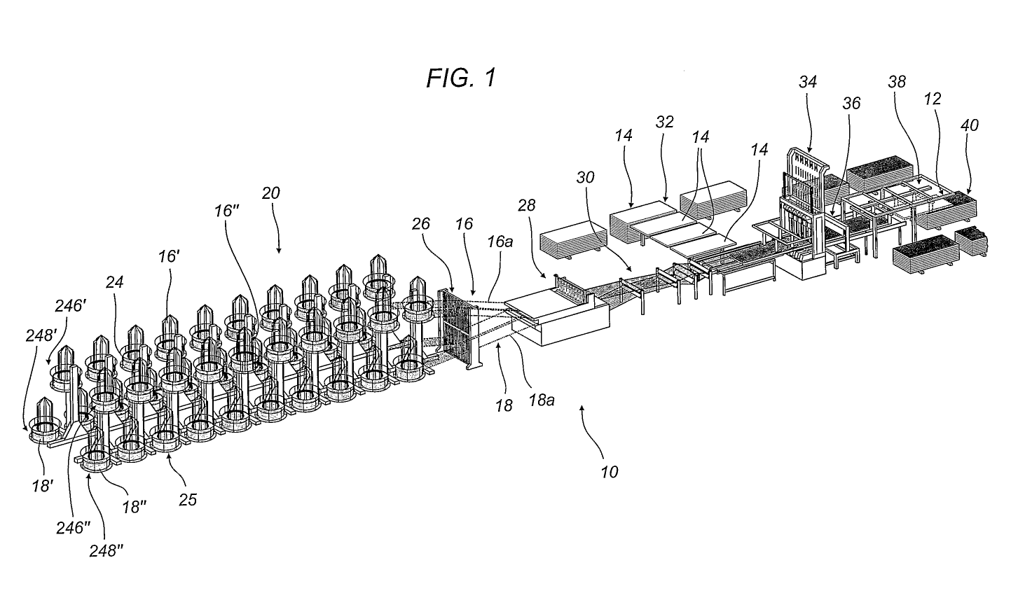

FIG. 1 illustrates a preferred embodiment 10 of an installation for making panels 12, in particular panels for constructing a building and which comprise a main panel body 14, made in particular of an insulating material, especially an expanded plastic material, preferably expanded polystyrene, and reinforcement means 16, 18, associated with the panel body 14.

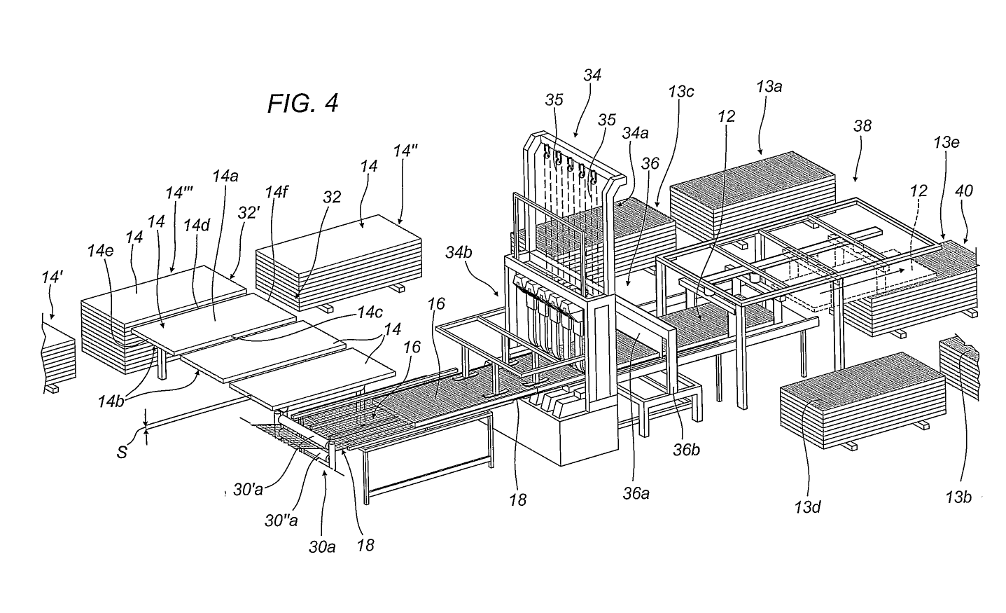

As clearly shown in FIG. 4, the panel body 14 extends mainly in two dimensions, having a suitable thickness “S”, large opposite transversal faces 14a, 14b and a peripheral profile defined by corresponding lateral faces 14c, 14d, 14e, 14f. As illustrated, the panel has a quadrangular, preferably rectangular, shape.

In particular, the reinforcement means 16, 18 are in the form of first and second reinforcement means associated with the main panel body 14 at, and substantially parallel with, the opposite transversal faces 14a, 14b of the panel body 14 itself.

The installation comprises, upstream to downstream, means 20, in the form of a magazine, for feeding the reinforcement means, means 34 for assembling the reinforcement means with the main panel body and means 38 for unloading the panels from the installation.

The installation also comprises, between the feed means 20 and the assembly means 34, means 28 for forming the reinforcement means and, between the assembly means 34 and the panel unloading means 38, means 36 for cutting the reinforcement means.

Also provided in the installation are means 32 for feeding the panel body 14 located between the means 28 for forming the reinforcement means and the means 34 for assembling the reinforcement means.

According to a particularly advantageous aspect of the installation, means are also provided for feeding in a longitudinal direction the first and second reinforcement means 16, 18 to be associated with the main panel body 14. More specifically, and equally advantageously, the means that feed the first and second reinforcement means 16, 18 to be associated with the main panel body 14 are designed to feed the reinforcement means 16, 18 simultaneously, the reinforcement means 16, 18 being fed in parallel for at least part of the feed path.

In particular, the first and second reinforcement means or elements, are in the form of respective long, continuous elements 16, 18 which are advanced lengthways in the direction along which the installation extends.

Further, as illustrated, the first and second reinforcement means 16 and 18 are located one above the other and fed at different heights, the first reinforcement means 16 being vertically spaced from the second reinforcement means 18 as they advance.

According to another aspect, means 32 are provided for feeding the panel body and being designed to advance the panel body 14 in a direction transversal to the feed direction of the reinforcement means 16, 18.

Further, as illustrated, the installation advantageously comprises means 32 that feed the panel bodies 14 sequentially, one after the other, the panel bodies 14 being aligned in a direction transversal to the longitudinal feed direction of the reinforcement means 16, 18.

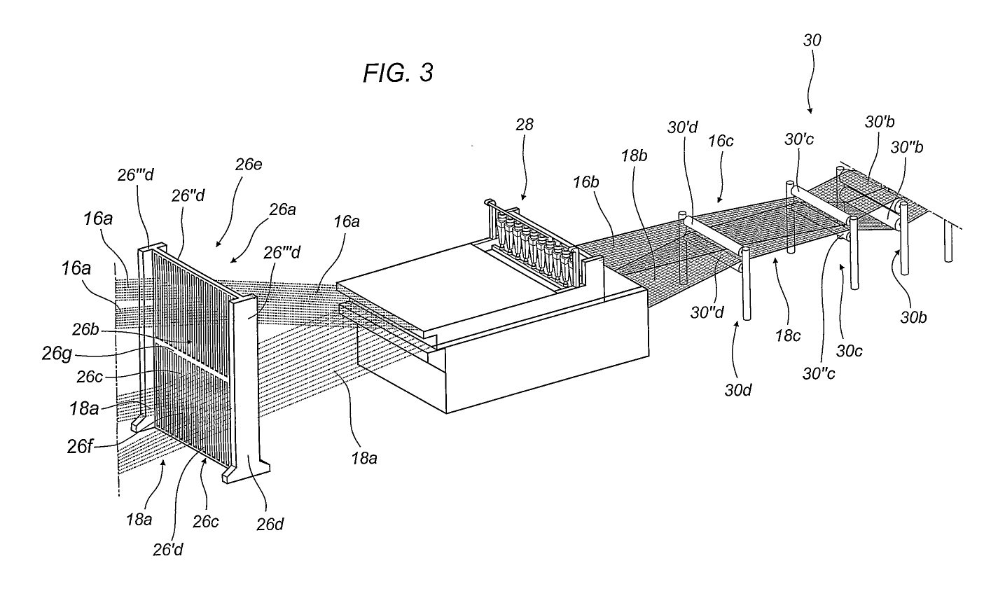

Advantageously, the reinforcement means 16, 18 are obtained from lengthwise reinforcement elements in the form of respective metal rods 16a, 18a or the like and crosswise reinforcement elements in the form of respective metal rods 16b, 18b or the like, the latter being associated, or welded, to the lengthwise rods 16a, 18a to make reinforcement means in the form of sheets of metallic mesh 16c, 18c, as shown by way of example in FIG. 3.

More in detail, the reinforcement means 16 and 18 comprise respective pluralities of metal rods 16a, 18a which are fed lengthways substantially in parallel with each other.

In practice, the long continuous rods 16a constituting the first reinforcement means 16 are fed lengthways and are kept at substantially the same height, like the long continuous rods 18a constituting the second reinforcement means 18, which are also fed lengthways at substantially the same height.

In practice, reinforcement means defining respective long reinforcement elements or strips 16, 18 are fed or advanced along the installation, and, in an upstream region of the installation, are simply in the form of long metal rods 16a and 18a and in a middle region of the installation are in the form of long continuous sheets of metallic mesh 16c, 18c.

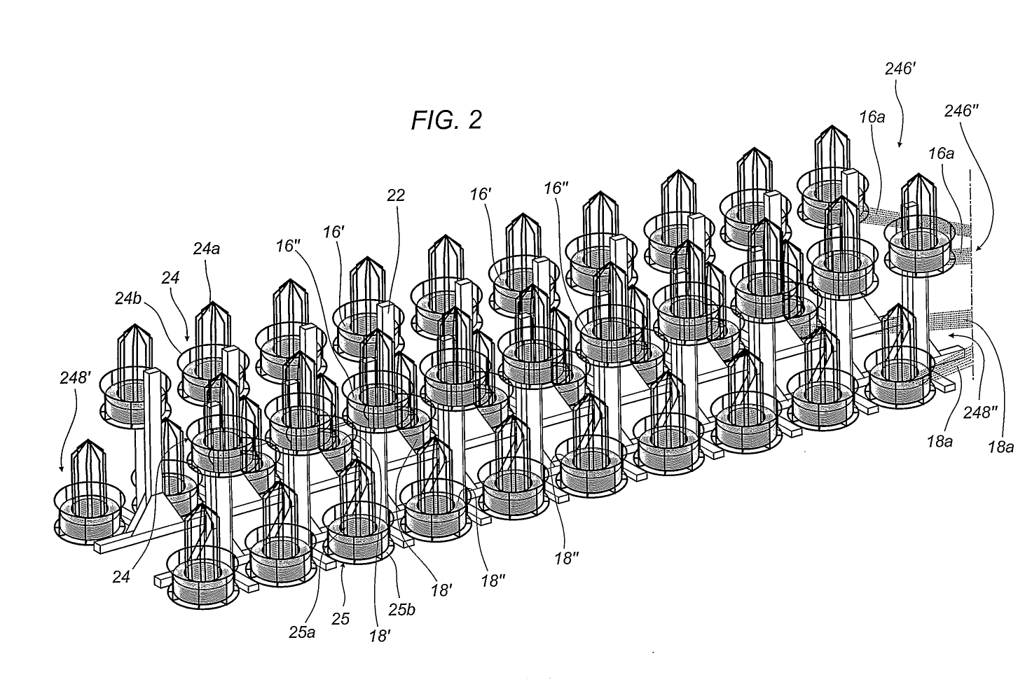

As shown in particular in FIG. 2, the means for feeding the reinforcement means comprise a magazine 20 for storing rolls 16′, 16″, 18′, 18″ from which the first and second reinforcement means 16, 18 are fed or advanced.

In the rolls, the respective rods are wound spirally. The rolls are of a kind well known to experts in the trade and do not need to be described in detail.

As illustrated, the magazine 20 advantageously comprises a frame 22 on which are mounted a plurality of seats 24, 25 for storing respective rolls 16′, 16″, 18′, 18″ from which the first and second reinforcement means 16, 18 are fed.

Advantageously, as illustrated, the seats 24 for the first reinforcement means 16 are mounted at a higher level than the seats 25 for the second reinforcement means 18.

As illustrated, the seats 24, 25 for the first and second reinforcement means 16, 18 are removably connected to the mounting frame 22, being in the form of corresponding baskets which comprise a central spindle 24a, 25a, constituting means for holding the baskets and having respective wide cages 24b, 25b at the base for accommodating the respective rolls of rod 16′ 16″, 18′, 18″.

Means are also provided, which are not illustrated in detail in the accompanying drawings, designed to turn the reels 24 and 25 so as to feed the rods 16a, 18a lengthways along the magazine 20.

The seats 24 for the first reinforcement means 16 comprise a first plurality of reels 246′ aligned with each other and a second plurality of reels 246″ aligned with each other, where said first and second pluralities 246′, 246″ of longitudinally aligned reels for the first reinforcement means 16 extend in parallel directions lengthways along the installation 10.

As illustrated, the reels for the reinforcement means 18 comprise a first plurality of reels 248′ aligned with each other and a second plurality of reels 248″ aligned with each other, where said first and second pluralities 248′, 248″ of longitudinally aligned reels for the second reinforcement means 18 extend in directions parallel to the installation 10.

Further, each row of reels 248′, 248″ for the second reinforcement means 18 extend parallel to the rows of reels 246′, 246″ for the first reinforcement means 16.

Also, the reels 246′, 246″ for the first reinforcement means 16′, 16″ are vertically offset with respect to respective reels 248′, 248″ for the second reinforcement means 18′ 18″. In practice, the individual seats 246′, 246″ for the first reinforcement means 16′, 16″ are not vertically aligned with the corresponding seats 248′, 248″ for the second reinforcement means 18′ 18″. Further, as illustrated, the seat rows 246′, 246″ for the first reinforcement means 16 are vertically aligned with the respective reel rows 248′, 248″ for the second reinforcement means 18. In this way, the reels 248′, 248″ below, for the second reinforcement means 18, can be easily accessed and handled, even though the magazine is relatively limited in width.

In other terms, the first and second pluralities 246′, 246″ of reels for the first reinforcement means 16′, 16″ and the first and second pluralities 248′, 248″ of reels for the second reinforcement means 18′, 18″ are vertically spaced from each other, and the respective pluralities 246′, 246″ or 248′ and 248″ are transversely spaced from each other.

It will be understood that the magazine 20, defining respective levels 246′, 246″ and 248′, 248″ for accommodating the rolls 16′, 16″ and 18′, 18″, might also be used in an independent machine used only for making reinforcement means or metallic mesh, fed alternately with the rods of the top level 246′, 246″ or of the bottom level 248′, 248″, in order to facilitate handling and loading of the rod rolls. In practice, when one level of rolls is finished, the rod feed could be changed over immediately to the rolls at the other level, and the finished rolls changed in due course with new ones without interrupting production. The plurality of levels 246′, 246″ and 248′, 248″ of rolls 16′, 16″ and 18′, 18″ might also be used to accommodate rods 16a, 18a of different sizes, for example, rod 16a of one gauge and rod 18a of a different gauge, to be used optionally according to production requirements.

Means 26 are advantageously provided for arranging the first and second lengthwise rods 16a, 18a according to a predetermined configuration.

As may be well inferred from FIG. 3, the means for arranging the lengthwise rods 16a, 18a over one another and according to a predetermined configuration or transversal distance comprise respective means or apparatus 26b, 26c for guiding the rods being fed lengthways and defining the first reinforcement means 16 and the second reinforcement means 18, respectively.

The means for guiding the lengthwise rods 16a, 18a of the first and second reinforcement means are in the form of respective vertical channels 26b, 26c located one above the other, through which the rods pass lengthways and which are made in a mounting frame 26a comprising upper and lower crossbars 26′d and 26″d, connecting respective uprights 26′″d transversely spaced from each other and from which there extend vertical rods 26e, 26f that form respective vertical channels. The guides or channels 26b, 26c are vertically aligned and separated from each other by a a separator or horizontal intermediate reinforcement crossbar 26g. Slidable in the vertical guides or channels 26b, 26c there are respective annular elements or guide rings, not illustrated in detail, into each of which a respective rod is inserted and guided lengthways.

Means 28 are also advantageously provided for applying the crosswise rods 16b, 18b of the reinforcement means 16, 18.

These means for applying the crosswise rods comprise respective means for feeding the crosswise rods 16b of the first reinforcement means 16 and second means for feeding the crosswise rods, 18b of the second reinforcement means 18. Said means for feeding the crosswise rods 16a, 16b of the reinforcement means are not illustrated in detail in the accompanying drawings.

Means are also provided for positioning the crosswise rods 16b of the first reinforcement means 16 under the respective lengthwise rods 16a and for positioning the crosswise rods 18b of the second reinforcement means over the respective lengthwise rods 18a.

More specifically, the means for positioning the crosswise rods are in the form of means for inserting respective crosswise rods 16b, 18b between the first and second lengthwise rods 16a, 18a. Preferably, the crosswise rods 16b, 18b are inserted with a transversal movement relative to the lengthwise direction of feed.

As illustrated, the means for applying the respective crosswise rods to the lengthwise rods to obtain respective sheets of metallic mesh 16c, 18c are in the form of a single unit 28 located downstream of, and longitudinally in line with, the guide means 26 and feed magazine 20.

In particular, the means for applying the crosswise rods to the respective lengthwise rods comprise means for joining or, more specifically, welding, the crosswise rods 16b, 18b to the respective lengthwise rods 16a, 18a, said means not being illustrated in detail in the accompanying drawings.

Advantageously, the installation contemplates the provision of means, labelled 30 in their entirety, for positioning the first and second reinforcement means, in particular in the form of continuous sheets 16c, 18c of metallic mesh, according to a predetermined spacing.

In particular, the first and second reinforcement means 16, 18 are positioned according to a predetermined vertical spacing large enough to accommodate, between the reinforcement means 16, 18, corresponding panel bodies 14, as described in more detail below.

As illustrated, the means for positioning the first and second reinforcement means according to a predetermined spacing comprise respective transmission means 30a designed to draw the first and second reinforcement means 16c, 18c closer to each other. As may be inferred from FIG. 4 in particular, the means 30a for drawing the first and second reinforcement means 16c, 18c closer to each other comprise respective first and second rollers 30′a, 30″a extending transversely and mounted between vertical columns, the first and second reinforcement means 16c, 18c being guided between said rollers 30′a, 30″a.

As illustrated in FIG. 3, the means for positioning the first and second reinforcement means according to a predetermined spacing also comprise transmission means 30b designed to move the first and second reinforcement means 16c, 18c away from each other. More specifically, the means for moving the first and second reinforcement means away from each other comprise respective first and second rollers 30′b, 30″b extending transversely and mounted between vertical columns, the first and second reinforcement means 16c, 18c being guided over the outer surfaces of the rollers.

Upstream of the spacing means 30b that move the first and second reinforcement means 16c, 18c away from each other, further means, labelled 30c in their entirety, are provided for drawing the continuous sheets 16c, 18c of metallic mesh closer to each other, said means comprising respective first and second rollers, labelled 30′c e 30″c, mounted transversely between respective vertical mounting columns and designed to receive the continuous sheets 16c, 18c of metallic mesh between them.

Upstream of the second rollers 30c that draw the reinforcement sheets closer together, second means are provided for moving the reinforcement sheets away from each other, comprising first and second rollers 30′d, 30″d for moving the sheets away from each other, extending transversely and mounted between respective vertical columns 30d. As illustrated, the continuous sheets 16c, 18c are guided over the opposite outer surfaces of the rollers 30′d, 30″d.

This keeps the continuous sheets 16c, 18c of metallic mesh in a taut state and constitutes means for tensioning the metallic mesh.

The reference numeral 32 in FIG. 4 denotes means for feeding the panel body 14 from a respective magazine, labelled 32′, where the panel bodies are stored 14.

The magazine of panel bodies 14 comprises a set of stacks, or dispensing areas, and, as one stack of panel bodies finishes, enables feed to continue from another stack without interruption. In practice, a first and a second stack 14′, 14″ are positioned at the sides of the transversal line for feeding the panel bodies 14. A third stack 14′″ of panel bodies 14 might also be provided at the longitudinal end of the transversal line for feeding the panel bodies 14.

Advantageously, the means 32 for feeding the panel body 14 are designed to insert the panel body 14 between the first and second reinforcement means 16, 18.

As illustrated, the means 32 for feeding and inserting the panel bodies 14 extend transversally and advance the panel bodies at substantially the same height as that at which the panels are advanced lengthways along the main line of the installation.

Means 34 are also provided, downstream of the means that insert the panel body 14, for joining the first and second reinforcement means 16, 18 to the panel body 14 that has been sandwiched between them.

The means 34 for joining the first and second reinforcement means 16, 18 to the panel body 14 sandwiched between them comprise means 34a for feeding a metal joining rod 35.

In practice, the joining rod 35 is cut to a suitable length and inserted into the panel body 14 with the respective ends of the joining rod laid on the first and second reinforcement means in such a way that they can be readily joined to them.

For this purpose, the means for joining the first and second reinforcement means to the panel body sandwiched between them comprise means 34b for welding the joining rod 35 to the first and second reinforcement means 16 and 18. Said welding means are not illustrated in detail in the accompanying drawings.

As illustrated, the means 34 that join the panel components to each other are located downstream of the means that insert the panel body between the first and second reinforcement means 16 and 18, and extend lengthways in line with the other stations or operating means that make the panel in the installation.

Means are also provided for separating the finished panel 12, said means being in the form of means for cutting the first and second reinforcement means 16, 18 and being labelled 36 in FIG. 4.

Advantageously, the separating means 36 are designed to cut the first and second reinforcement means 16, 18 simultaneously at the respective longitudinal end of the panel 12.

Preferably, the cutting means 36 comprise a cutting blade 36a that moves vertically between a raised position in which the strip of panels can pass freely and a cutting position. At the cutting position, the cutting means simultaneously cut the first and second reinforcement means 16, 18 at their corresponding longitudinally aligned ends.

As illustrated, the blade 36a is mounted on a mounting frame 36b.

The numeral 38 in FIG. 4 denotes means for unloading the finished panel 12 from the production line.

The finished panels 12 are then placed in a storage bay, at 40, from where they can be despatched by suitable transport means.

The means 38 for unloading the panel 12 from the line are also situated lengthways in line with the other stations forming part of the installation.

The panel 12 storage bay comprises a set of stacks, or accumulation areas, and, as one stack of panels 12 is completed, enables another stack to be started without interrupting outfeed from the installation. In practice, the unloading means 38 form respective stacks 13a, 13b at the sides of the production line. In addition, second stacks 13c, 13d might be formed at the sides of the line, in particular aligned lengthways with the first lateral stacks 13a, 13b. Yet another stack 13e of panels 12 might be formed at the longitudinal end of the production line.

The installation therefore makes it possible to work simultaneously on first and second reinforcement means and to make a panel 12 in a single production line by assembling the reinforcement means 16, 18 with a main panel body 14. This has the advantage of minimizing factory floor space and labour required to make the panels.

Obviously, it will be understood that the panels can be made in any selected length and/or width, according to market or production requirements.

The installation also provides a process for making panels 12, in particular panels used for constructing a building, each panel comprising a main panel body 14, made in particular of an insulating material, especially an expanded plastic material, preferably expanded polystyrene, and reinforcement means 16, 18 associated with the panel body 14. According to this process, first reinforcement means 16 and second reinforcement means 18 to be associated with the main panel body 14 are fed in a longitudinal direction.

According to an advantageous aspect of the process, first reinforcement means 16 and second reinforcement means 18 to be associated with the main panel body 14 are fed simultaneously and in parallel with each other.

Also, according to the process, first and second reinforcement means 16, 18, in the form of long, continuous elements are advanced at different heights, the first reinforcement means 16 advancing at a level above that of the second reinforcement means 18.

Further, the panel body 14 is advanced in a direction transversal to the feed direction of the reinforcement means 16, 18. The panel bodies 14 are advanced in sequence and are aligned with each other.

According to another aspect of the process, respective pluralities of metal rods 16a, 18a, constituting first and second reinforcement means 16, 18 to be associated with the panel body 14, are fed lengthways and the metal rods 16a, 18a are combined with respective crosswise rods 16b, 18b to form sheets 16c, 18c of reinforcement mesh.

The crosswise rods 16b of the first reinforcement means 16 are positioned under the respective lengthwise rods 16a and the crosswise rods 18b of the second reinforcement means 18 are positioned over the respective lengthwise rods 18a.

According to the process, the crosswise rods 16b, 18b are inserted transversely between the first and second reinforcement means 16a, 18a.

According to another advantageous aspect of the process, the panel body 14 is inserted between the first and second reinforcement means 16, 18 and the first and second reinforcement means 16, 18 are joined to each other with the panel body 14 sandwiched between them.

According to the process, the first and second reinforcement means 16, 18, and more specifically, their lengthwise rods are cut simultaneously at the respective end of the panel body.

According to the process, the first and second reinforcement means 16, 18 are cut after the panel body 14 has been inserted between them.

Other advantageous aspects of the process may be inferred from the foregoing description of the installation.

The invention described above is susceptible of industrial application and may be modified and adapted in several ways without thereby departing from the scope of the inventive concept. Moreover, all the details of the invention may be substituted by technically equivalent elements.

1-93. (canceled)

94. An installation (10) for making construction articles, said articles being panels (12), or parts thereof, used for constructing a building, each panel (12) comprising a main panel body (14), made in particular of an insulating material, especially an expanded plastic material, preferably expanded polystyrene, and reinforcement means (16, 18) associated with the panel body (14); the installation comprising means for feeding in a longitudinal direction first reinforcement means (16) and second reinforcement means (18) to be associated with the main panel body (14), said first and second reinforcement means (16, 18) comprising respective pluralities of metal rods (16a, 18a) provided with corresponding crosswise rods (16b, 18b) to form respective sheets (16c, 18c) of metallic mesh and wherein it comprises means (32) for feeding the panel body (14).

95. The installation according to claim 94 wherein it comprises means for simultaneously feeding first reinforcement means (16) and second reinforcement means (18) to be associated with the main panel body (14).

96. The installation according to claim 94, wherein it comprises means for feeding in parallel with each other first reinforcement means (16) and second reinforcement means (18) to be associated with the main panel body (14).

97. The installation according to claim 94, wherein the first and second reinforcement means (16, 18) are kept spaced apart as they are made to advance.

98. The installation according to claim 94, wherein the first reinforcement means (16) are above the second reinforcement means (18).

99. The installation according to claim 94, wherein it comprises means for feeding lengthways respective pluralities of metal rods (16a, 18a), constituting first and second reinforcement means (16, 18) to be associated with the panel body (14).

100. The installation according to claim 99, wherein the means for feeding the reinforcement means comprise a magazine (20) for storing respective means (16′, 16″, 18′, 18″) from which the first and second reinforcement means (16, 18) are fed the magazine (20) comprises a frame (22) on which a plurality of seats (24, 25) for storing respective rolls (16′, 16″, 18′, 18″) is mounted, from which first and second reinforcement means (16, 18) are fed, and wherein the seats (24) for storing the first reinforcement means (16) are mounted at a higher level than the reels (25) for storing the second reinforcement means (18).

101. The installation according to claim 100, wherein the reels for the first reinforcement means (16) and the reels for the second reinforcement means (18) are vertically offset from each other.

102. The installation according to claim 99, wherein it comprises means (28) for applying the crosswise rods (16b, 18b) of the respective reinforcement means (16, 18).

103. The installation according to claim 102, wherein the means for applying the crosswise rods (16b, 18b) comprise respective means for feeding the crosswise rods (16b) of the first reinforcement means (16) and second means for feeding the crosswise rods (18b) of the second reinforcement means (18), wherein the means for applying the crosswise rods comprise means (28) for positioning the crosswise rods (16b) of the first reinforcement means (16) under the respective lengthwise rods (16a) and the means for applying the crosswise rods comprise means for positioning the crosswise rods (18b) of the second reinforcement means (18) over the respective lengthwise rods (18a).

104. The installation according to claim 94, wherein it comprises means for feeding the panel body (14) in a direction transversal to the feed direction of the reinforcement means (16, 18).

105. The installation according to claim 94, wherein the means (32) for feeding the panel body (14) insert the panel body (14) between the first and second reinforcement means (16, 18).

106. The installation according to claim 94, wherein it comprises means (34) designed to join the first and second reinforcement means (16, 18) to each other with the panel body (14) sandwiched between them.

107. The installation according to claim 106, wherein the means for joining the first and second reinforcement means (16, 18) to each other with the panel body (14) sandwiched between them comprise means (34b) for inserting the joining rod between the first and second reinforcement means (16, 18) and into the panel body (14).

108. The installation according to claim 94, wherein it comprises means (36) for cutting the first and second reinforcement means (16, 18).

109. The installation according to claim 108, wherein the cutting means (36) are designed to cut the first and second reinforcement means (16, 18) simultaneously.

110. The installation according to claim 94, wherein it comprises means (28) for forming the reinforcement means (16, 18), located between the means (20) that feed the reinforcement means and the means (34) that assemble the panel (12).

111. The installation according to claim 110, wherein it comprises means (36) for cutting the reinforcement means, located between the assembly means (34) and the means (38) that unload the panels (12).

112. The installation according to claim 96, wherein it comprises means (32) for feeding the panel body (14), located between the means (28) that form the reinforcement means and the means (34) that assemble the reinforcement means with the panel body.

113. An installation (10) for making construction articles, the installation comprising means for feeding in a longitudinal direction first reinforcement means (16) and second reinforcement means (18), wherein the first reinforcement means (16) are above the second reinforcement means (18), wherein it comprises means for feeding lengthways respective pluralities of metal rods (16a, 18a), constituting first and second reinforcement means (16, 18) to be associated with the panel body (14) and means (28) for applying the crosswise rods (16b, 18b) of the respective reinforcement means (16, 18), wherein the means for applying the crosswise rods (16b, 18b) comprise respective means for feeding the crosswise rods (16b) of the first reinforcement means (16) and second means for feeding the crosswise rods (18b) of the second reinforcement means (18), and wherein the means for applying the crosswise rods comprise means (28) for positioning the crosswise rods (16b) of the first reinforcement means (16) under the respective lengthwise rods (16a) and the means for applying the crosswise rods comprise means for positioning the crosswise rods (18b) of the second reinforcement means (18) over the respective lengthwise rods (18a).
